(19) United States
(12) Patent Application Publication
(10) Pub. No.: US 2026/0366803 A1
(43) Pub. Date: Nov. 19, 2026

(54) ADDITIONAL MODE CONTROL SYSTEM OF REFRIGERATOR

(71) Applicant: LG ELECTRONICS INC., Seoul (KR)

(72) Inventors: Jihoon KIM, Seoul (KR); Bo Kyung PARK, Seoul (KR); Jungjae LEE, Seoul (KR); Changwon KIM, Seoul (KR); Kyunghyun SEO, Seoul (KR); Sungheum KWON, Seoul (KR)

(73) Assignee: LG ELECTRONICS INC., Seoul (KR)

(21) Appl. No.: 19/099,601

(22) PCT Filed: Apr. 10, 2023
(86) PCT No.: PCT/KR2023/004797

§ 371 Date: Jan. 29, 2025

(30) Foreign Application Priority Data
Jul. 29, 2022 (KR) 10-2022-0094837

(51) Int. Cl. F25D 29/00; G05D 7/06

(52) U.S. Cl. CPC F25D 29/00; G05D 7/0623; F25D 2331/806

(57) ABSTRACT

An additional mode control system of a refrigerator, according to an embodiment, enables, when an additional mode capable of implementing a new function of a dispenser is developed, a user to upgrade the additional mode for a new function of the dispenser only by simple operation of a user terminal, thereby increasing user convenience in upgrading a function.

### FIELD

The present disclosure relates to a system for controlling an additional mode of a refrigerator.

### DESCRIPTION OF RELATED ART

A refrigerator is a home appliance that supplies cold air generated using circulation of a refrigerant to a storage compartment to store various types of storage objects in a storage compartment in a fresh state for a long time.

The refrigerator includes a cabinet defining a storage compartment and a door connected to a front surface of the cabinet to open and close the storage compartment.

A dispenser capable of discharging water and/or ice is disposed at the door of the refrigerator, thereby increasing the convenience of a user who wants to take out water and ice.

In this regard, the refrigerator includes a controller for controlling an operation of an electronic device product such as a refrigerator and a dispenser.

The controller may include product driving software for operating a product, and may operate the product according to the program logic of the software.

Since a new function of an electronic device may be continuously upgraded even after the electronic device has been sold, there is a need to upgrade software of an existing electronic device.

In addition, it may be difficult to implement or explain a newly upgraded function only using a display showing a function of the existing electronic device.

For example, since not only software of the electronic device but also hardware itself thereof may be an old version, there is a need to upgrade and execute the new function with minimal effect from the existing device's hardware level of the existing electronic device.

### DISCLOSURE

### Technical Purpose

A purpose of the present disclosure is to provide an additional mode control system of a refrigerator capable of upgrading an additional mode that may provide a new function to the refrigerator.

Another purpose of the present disclosure is to provide an additional mode control system of a refrigerator capable of providing a new function while being as unaffected as possible by a version of a product to be upgraded.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims and combinations thereof.

### Technical Solutions

According to an aspect of the present disclosure, there is provided a system for controlling an additional mode of a refrigerator, the refrigerator including a dispenser, wherein an additional mode of the dispenser can be upgraded by a user terminal or a server, wherein the user terminal includes a user interface providing information on the additional mode.

More specifically, the refrigerator includes the dispenser, wherein the additional mode thereof is upgradable by a user terminal or a server, thereby enabling the user to upgrade an additional mode of a new function in an existing dispenser even via a simple manipulation of the user terminal.

In addition, the user terminal includes the user interface for providing information on the additional mode. Thus, information on the new function may be acquired and executed by the user performing a simple manipulation of the user terminal with being insignificantly affected by the state of the dispenser having various old versions of software and hardware.

The system for controlling the additional mode of the refrigerator comprises: a user terminal; a server which communicates with the user terminal; a refrigerator which communicates with at least one of the user terminal and the server, and includes a dispenser, wherein the additional mode of the dispenser is upgradable by the user terminal or the server; a user interface provided on the user terminal and configured to provide information on the additional mode; an input unit provided on the dispenser and configured to receive a user command according to the additional mode; and a controller configured to control execution of the additional mode in response to the user command input to the input unit.

In addition, according to another embodiment of the present disclosure, a start point of the first set time duration may start after the door is opened and then closed again.

Furthermore, in another embodiment of the present disclosure, the additional mode may be a constant water quantity supply mode in which a predetermined amount of water is discharged.

Furthermore, in another embodiment of the present disclosure, the user interface may provide an option for allowing a user to arbitrarily adjust and select a volume of water to be discharged in the constant water quantity supply mode.

Furthermore, in another embodiment of the present disclosure, the dispenser may include a plurality of buttons corresponding to the input unit, wherein when one of the buttons has been selected and pressed for a predetermined time duration, the controller may be configured to execute the constant water quantity supply mode.

Furthermore, in another embodiment of the present disclosure, the plurality of buttons may include a first button, a second button, and a third button, wherein in the constant water quantity supply mode, the first button, the second button, and the third button may correspond to different discharged water volumes, respectively.

Furthermore, in another embodiment of the present disclosure, the dispenser may further include a lever, wherein when the lever is pressed in the constant water quantity supply mode, water may be discharged at a water volume corresponding to the selected button.

Furthermore, in another embodiment of the present disclosure, in the constant water quantity supply mode, the controller may be configured to: detect a water supply flow rate based on a pulse value using a flow sensor for a predetermined time duration so that water is discharged at a water volume corresponding to the selected button; determine a water pressure; and in response to that a target pulse value corresponding to the determined water pressure has been reached, terminate water discharge and execute the constant water quantity supply mode.

Furthermore, in another embodiment of the present disclosure, when one of the plurality of buttons has been pressed for a predetermined time duration in the constant water quantity supply mode or when the constant water quantity supply mode is not executed for a predetermined time duration, the constant water quantity supply mode may be deactivated.

Furthermore, in another embodiment of the present disclosure, the additional mode may be an ice-making completion notification mode for guiding completion of ice-making of the dispenser.

Furthermore, in another embodiment of the present disclosure, in the ice-making completion notification mode, the controller may be configured to detect full-ice of the dispenser and to allow a notification sound to sound in a process of ice removal.

Furthermore, in another embodiment of the present disclosure, the user interface may provide an option for allowing a user to select on or off of the ice-making completion notification mode.

### Technical Effects

According to the present disclosure, when the additional mode capable of implementing a new function of the dispenser is developed, the user may upgrade the additional mode of the new function in the dispenser by simply manipulating the user terminal, thereby increasing user convenience for upgrading the function.

In addition, according to the present disclosure, the user terminal has the user interface which provides the information on the additional mode to be upgraded. Thus, information on the new function may be acquired and executed by the user performing a simple manipulation of the user terminal with being insignificantly affected by the state of the dispenser having various old versions of software and hardware.

In addition, according to the present disclosure, the constant water quantity supply mode in which water can be discharged at a desired water volume can be upgraded as the additional mode in the dispenser. Thus, the user can newly provide a function of the constant water quantity supply mode to the existing dispenser via a simple manipulation of the user terminal, thereby improving user convenience.

In addition, according to the present disclosure, the ice-making completion notification mode for guiding the completion of the ice making in the dispenser can be upgraded as an additional mode in the dispenser. Thus, the user can newly provide a function of the ice-making completion notification mode to the existing dispenser via a simple manipulation of the user terminal, thereby improving user convenience.

In addition to the above-described effects, specific effects of the present disclosure will be described together while describing specific matters for implementing the present disclosure.

### BRIEF DESCRIPTION OF DRAWINGS

FIG. 1 is a perspective view of a refrigerator according to an embodiment of the present disclosure.

FIG. 2 is a view illustrating a dispenser provided at a refrigerator door.

FIG. 3 illustrates a flowchart of upgrading an additional mode of the refrigerator.

FIG. 4 illustrates an input unit provided to a dispenser in which a constant water quantity supply mode is upgraded.

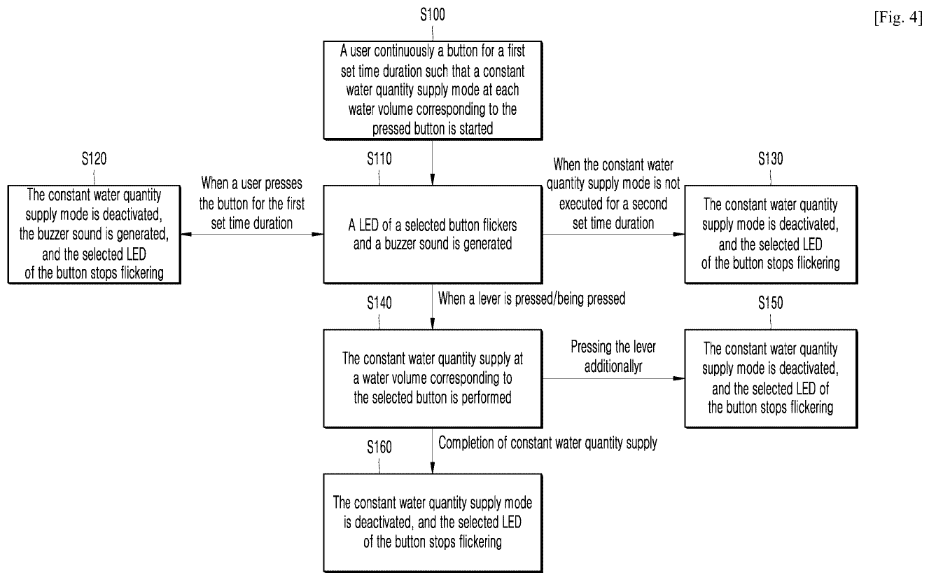

FIG. 5 is a flowchart of a constant water quantity supply mode according to an embodiment of the present disclosure.

FIG. 6 illustrates a flow of volume extraction according to a constant water quantity supply mode and selection of a water pressure zone.

FIG. 7 is a flowchart illustrating a water supply logic according to selection of a water pressure zone.

FIG. 8 illustrates a user interface of a user terminal providing an upgrade alarm indication.

FIG. 9 illustrates a user interface of a user terminal providing upgraded additional mode information.

FIG. 10 illustrates a user interface of a user terminal in which a user may arbitrarily adjust a quantity of water discharged in a constant water quantity supply mode.

FIG. 11 illustrates a user interface of a user terminal capable of setting on/off of an ice-making completion notification sound.

FIG. 12 is a flowchart illustrating an ice removal operation and a notification period of a notification sound through a controller after an ice-making completion notification mode is upgraded as an additional mode.

### DETAILED DESCRIPTIONS

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, when it is determined that a detailed description of the publicly known technology related to the present disclosure may unnecessarily obscure the gist of the present disclosure, the detailed description thereof will be omitted. Hereinafter, a preferred embodiment according to the present disclosure will be described in detail with reference to the attached drawings. In the drawings, identical reference numerals are used to indicate identical or similar components.

Although first, second, etc. are used to describe various components, these components are not limited by these terms. These terms are merely used to distinguish one component from another component. Thus, unless specifically stated to the contrary, the first component may be the second component.

As used herein, unless otherwise stated, each component may be provided as one or more components.

It will also be understood that when a first element or layer is referred to as being present “on” a second element or layer, the first element may be disposed directly on the second element or may be disposed indirectly on the second element with a third element or layer being disposed between the first and second elements or layers. It will also be understood that when a first element or layer is referred to as being present “under” a second element or layer, the first element may be disposed directly under the second element or may be disposed indirectly under the second element with a third element or layer being disposed between the first and second elements or layers.

It will be understood that when an element or layer is referred to as being “connected to”, or “coupled to” another element or layer, it may be directly connected to or coupled to another element or layer, or one or more intervening elements or layers therebetween may be present.

As used herein, the singular constitutes “a” and “an” are intended to include the plural constitutes as well, unless the context clearly indicates otherwise. Further, the terms “comprise”, “comprising”, “include”, and “including” as used herein should not be construed as necessarily including all of various components or steps as described herein, and may be construed as excluding some components or some steps thereof. It will be further understood that the terms “comprise”, “comprising”, “include”, and “including” as used herein specify presence of a component or a step, but do not preclude the presence or addition of another component or step.

As used herein, the singular constitutes “a” and “an” are intended to include the plural constitutes as well, unless the context clearly indicates otherwise. Further, the terms “comprise”, “comprising”, “include”, and “including” as used herein should not be construed as necessarily including all of various components or steps as described herein, and may be construed as excluding some components or some steps thereof. It will be further understood that the terms “comprise”, “comprising”, “include”, and “including” as used herein specify presence of a component or a step, but do not preclude the presence or addition of another component or step.

Throughout the present disclosure, “A and/or B” means A, B, or A and B, unless otherwise specified, and “C to D” means C inclusive to D inclusive unless otherwise specified.

Hereinafter, a refrigerator according to some embodiments of the present disclosure will be described.

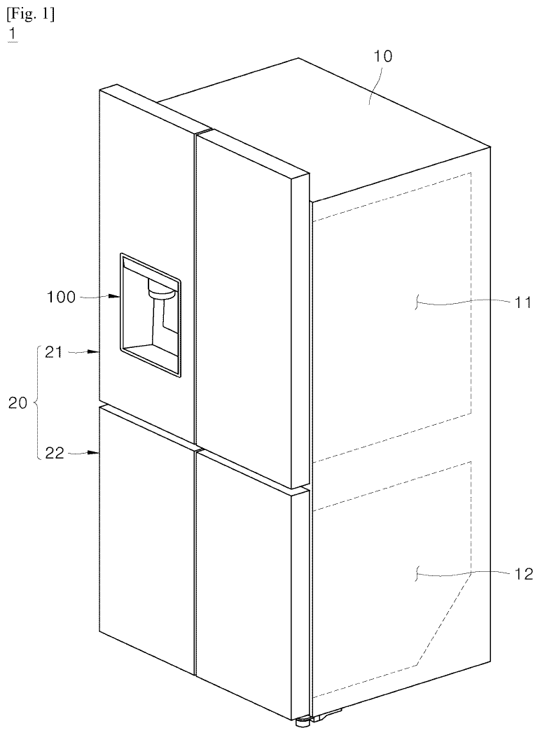

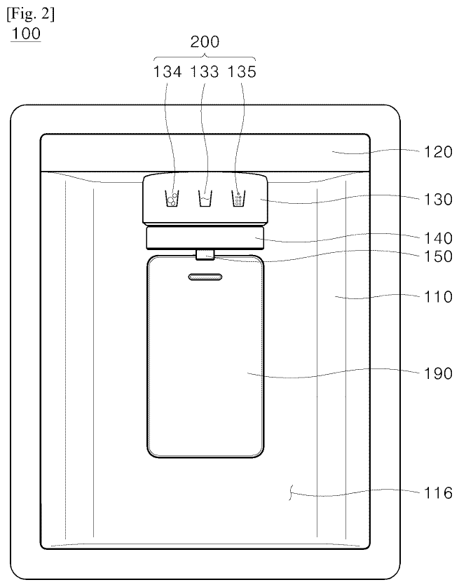

The refrigerator 1 including a dispenser 100 installed at a door 20 will be described with reference to FIGS. 1 and 2.

The refrigerator 1 may include a cabinet 10 having a storage space defined therein and a door 20 for opening and closing the storage space.

The storage space may be divided into a first space 11 as an upper spaced and a second space 12 at a lower space. However, the present disclosure is not limited thereto. The door 20 may also include a first door 21 for opening and closing the first space 11 and a second door 22 for opening and closing the second space 12.

At least one of the first door 21 and the second door 22 may be a pivotable door. Alternatively, a single door 20 may be a pivotable door. In the present embodiment, an example in which two first doors 21 are respectively disposed at left and right sides will be described.

The first door 21 may be pivotably connected to the cabinet 10 via a hinge device.

One of the two first doors 21 may include the dispenser 100. The dispenser 100 may discharge water and/or ice.

The dispenser 100 may include a dispenser housing 110. A portion of the dispenser housing 110 may be recessed rearwards to form a space 116 in which a cup or container may be received.

A lever 190 manipulated by a user to take out water or ice may be positioned at the dispenser housing 110. The lever 190 may be coupled to a rear wall of the dispenser housing 110 so as to be pivotable in the space 116 of the dispenser housing 110.

The dispenser 100 may further include a dispenser cover 120 coupled to the dispenser housing 110. The dispenser cover 120 may be coupled to a front surface of the dispenser housing 110 to constitute a portion of an outer appearance of the dispenser 100.

The dispenser cover 120 may include a body 130 protruding from the space 116.The body 130 may serve as a display.

The body 130 may have a round shape in which a plurality of buttons 133, 134, and 135 are provided on a front surface thereof. The plurality of buttons 133, 134, and 135 may serve as a display.

The plurality of buttons 133, 134, and 135 may be arranged in a horizontal direction while being disposed on the body 130. The plurality of buttons 133, 134, and 135 may include first to third buttons.

The first button 133 is a water selection button selected to switch an operation state to a state in which water can be taken out. Each of the second button 134 and the third button 135 is an ice selection button selected to switch the operation state to a state in which ice can be dispensed. In addition, the second button 134 and the third button 135 are buttons for selecting a type of the ice.

The second button 134 is a button selected to take out general ice, and the third button 135 is a button to select flake ice (crushed ice). The general ice refers to ice itself generated in an ice making device (not shown), and the flake ice refers to ice in a state in which the general ice has been crushed by a blade.

The first button 133 may be disposed between the second button 134 and the third button 135. However, an embodiment of the present disclosure is not limited thereto.

The dispenser 100 may further include a sensing assembly (not shown) (or a light emitting assembly) that senses button manipulation of the buttons 133, 134, and 135 and irradiates light in response to the button manipulation of the buttons 133, 134, and 135.

The sensing assembly (not shown) may include a switch for sensing mechanical manipulation of the buttons 133, 134, and 135, or may include a touch sensor for sensing a change in capacitance thereof when the buttons 133, 134, and 135 are touched. In the present embodiment, there is no limitation on a type of the sensor for detecting the manipulation of the buttons 133, 134, and 135.

Accordingly, the plurality of buttons 133, 134, and 135 may be an input unit 200 that receives a user's command.

For example, the user may input a command by touching the plurality of buttons 133, 134, and 135 which act as the input unit 200.

In this case, the input command may be set to vary according to a time when the user touches the input unit 200.

The sensing assembly (not shown) may include first to third light emitting elements. When the first button 133 is selected, light may be irradiated from the first light emitting element to the first button 133 or a surrounding around the first button 133. When the second button 134 is selected, light may be irradiated from the second light emitting element to the second button 134 or a surrounding around the second button 134. When the third button 135 is selected, light may be irradiated from the third light emitting element to the third button 135 or a surrounding around the third button 135.

In this case, the light emitting element LD may be an LED, but is not limited thereto.

The auxiliary body 140 may be disposed under the body 130 so as to be connected to a lower end of the body 130. A discharge port 150 for discharging water may be disposed at a lower end of the auxiliary body portion 140 so as to protrude downwards.

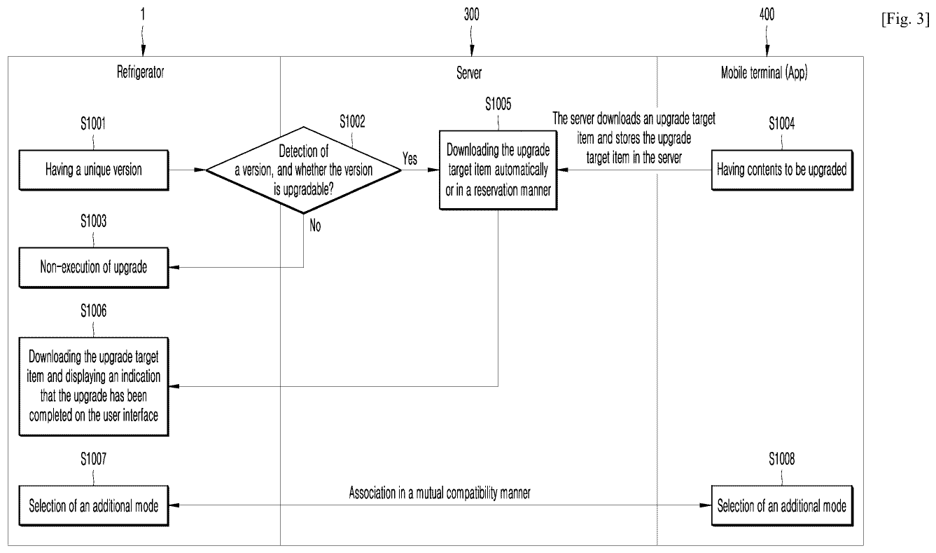

Referring to FIG. 3, an additional mode control system of the refrigerator 10 according to the present disclosure may include the refrigerator 1 including the dispenser 100, a server 300, and a user terminal 400.

The refrigerator 1 may communicate with at least one of the server 300 and the user terminal 400.

The user terminal 400 may communicate with the server 300.

Each of the refrigerator 1 and the user terminal 400 may include a communication module, and an example of the communication module may be a Wi-Fi module.

The additional mode control system of the refrigerator may include a user interface.

Information on an additional mode which is capable of upgrading the function of the refrigerator 1 may be displayed on the user interface.

In this case, the information on the additional mode may be various types of information such as a guide on the installation of the upgrade, a description of the operation of the additional mode, and an input screen for the operation of the additional mode.

The user interface may receive a user's command via a touch input or the like.

The user interface may be provided to at least one of the user terminal 400 and the refrigerator 1.

An example of the user interface may be a display of the refrigerator 1. In this case, the display of the refrigerator 1 may include a touch screen for receiving the user's command in a touch manner.

Another example of the user interface may be a display of the user terminal 400. In this case, the display of the user terminal 400 may include a touch screen for receiving a user's command in a touch manner.

Hereinafter, for convenience, an example in which the user interface is the display of the user terminal 400 will be described. However, the present disclosure it is not limited to the example in which the user interface is the display of the user terminal 400, and the user interface may be the display provided in the refrigerator 1.

The additional mode control system of the refrigerator may further include a controller 500.

Examples of the controller 500 may be a controller of the refrigerator 1, a controller of the server 300, a controller of the user terminal 400, or a combination of these controllers.

The controller 500 may control the dispenser 100 of the refrigerator 1 according to an input of the user interface or the input unit 200.

In one example, the refrigerator 1, the server 300, and the user terminal 400 may communicate with each other, and the user may upgrade the refrigerator 1 using the user terminal 400.

The user terminal 400 may be an electronic device configured to request data processing to the server 300 or the refrigerator 1 or receive the data processing result therefrom through a network and provide a related function, and may be a smartphone, a laptop computer, a notebook computer, a smart TV, or a wearable device having such a function.

The user terminal 400 may be connected to the refrigerator 1 through a short-range network, for example, Wi-Fi or Bluetooth.

When an upgrade target item is transmitted through the user terminal 400, the upgrade target item may be downloaded to the server 300, and the refrigerator 1 may download and upload the upgrade target item from the server 300.

The refrigerator 1 may include a function built-in therein when selling a product. Further, new functions may be continuously added thereto.

In the present disclosure, an embodiment in which an additional mode for implementing a new function of the dispenser 100 of the refrigerator 1 will be described.

The refrigerator 1 may have a unique version in S1001.

The refrigerator 1 or the server 300 may detect the unique version of the refrigerator 1 and identify whether the unique version is an upgradeable version in S1002.

When the unique version is not the upgradeable version, the refrigerator 1 maintains the existing unique version and does not execute the upgrade in S1003.

In one example, the user terminal 400 may include a specific app capable of controlling and managing the refrigerator 1, and the user may input contents as an upgrade target to the refrigerator 1 through the specific app. The user terminal 400 may have contents to be upgraded in S1004.

The server 300 may download an upgrade target item (contents) from the user terminal 400 and store the upgrade target item in the server. The server 300 may download the upgrade target item automatically or in a reservation manner in S1005.

When the unique version of the refrigerator 1 is the upgradeable version, the server 300 may transmit the upgrade target item (contents) to the refrigerator 1. The refrigerator 1 may download the upgrade target item. When the upgrade has been completed, the refrigerator 1 may display the indication that the upgrade has been completed on the user interface in S1006.

The additional mode control system of the refrigerator according to the present disclosure as described above includes the user terminal 400, the server 300, and the refrigerator 1 communicating with at least one of the user terminal 400 and the server 300 and including the dispenser 100 whose the additional mode is upgradable by the user terminal 400 or the server 300.

The user may identify whether the upgrade of the additional mode has been completed through the user interface of the user terminal 400 that provides information on the additional mode.

When the additional mode including the new function of the dispenser 100 in the refrigerator 1 has been upgraded, the user may input a command for executing the additional mode to the input unit 200 provided in the dispenser 100.

When the user's command has been input to the input unit 200, the controller 500 may control the execution of the additional mode according to the input user's command.

In one example, the refrigerator 1 and the user terminal 400 may be associated with each other.

For example, when the additional mode is selected in the refrigerator 1 in S1007, the selected additional mode may be activated in the user terminal 400 in an association manner with the refrigerator 1. When the additional mode is selected in the user terminal 400 in S1008, the selected additional mode may be activated in the refrigerator 1 in an association manner with the user terminal 400.

As described above, according to the present disclosure, when the additional mode capable of implementing a new function of the dispenser 100 is developed, the user may upgrade the additional mode of the new function to the dispenser 100 with only a simple manipulation of the user terminal 400, thereby increasing user convenience for upgrading the function.

Hereinafter, the upgraded additional mode will be described in more detail.

For example, the additional mode may be a constant water quantity supply mode in which a predetermined constant amount of water is discharged.

When the constant water quantity supply mode is upgraded as the additional mode in the dispenser 100, each of the first button 133, the second button 134, and the third button 135 provided on the body 130 of the dispenser 100 may act as the input unit 200 through which the user inputs a command so that each of different quantities of water is discharged.

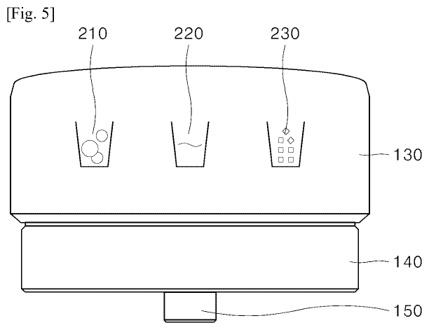

Referring to FIG. 5, the second button 134 may be a first input unit 210, the first button 133 may be a second input unit 220, and the third button 135 may be a third input unit 230.

For example, the controller 500 may be configured to allow water of 250 ml to be discharged when the user inputs a command to the first input unit 210, to allow water of 500 ml to be discharged when the user inputs a command to the second input unit 220, and to allow water of 1,000 ml to be discharged when the user inputs a command to the third input unit 230.

Specifically, when the user inputs a command to the input unit and then presses the lever 190 of the dispenser 100, the water may be discharged at a volume corresponding to the selected button, that is, the input unit.

In this case, the amount of water to be discharged is determined as a preset amount. Thus, the present disclosure is not limited thereto, and the amount of water to be discharged may vary via various schemes such as a user's setting or an upgrade of the additional mode.

As described above, according to the present disclosure, when a new additional mode is upgraded in the dispenser 100, a function setting on the input unit capable of executing a function of the newly added additional mode may be arbitrarily allocated to the input unit provided in the dispenser 100 before the upgrade, so that the new function may be executed without limitation of the function only via upgrading the software.

A flowchart of the constant water quantity supply mode according to an embodiment of the present disclosure will be described with reference to FIG. 5.

After the constant water quantity supply mode as a new additional mode has been upgraded in the dispenser 100, the user may perform constant water quantity supply through a following flowchart.

In step S100, when the user continuously presses one of the first button 133, the second button 134, and the third button 135 as the plurality of buttons of the dispenser 100 for a first set time duration, a constant water quantity supply mode at each water volume corresponding to the pressed button may be started.

In this case, the first set time duration may be set to 3 seconds. However, the first set time duration may vary, and is not limited thereto.

Even after the constant water quantity supply mode has been upgraded in the dispenser 100, before the user starts the constant water quantity supply mode, the constant water quantity supply mode does not start, and the dispenser 100 simply operates with its existing function.

For example, when one of the first button 133, the second button 134, and the third button 135 of the dispenser 100 is pressed for a short time, during a time shorter than the first set time duration, the constant water quantity supply mode is not executed.

Accordingly, in this case, the first button 133, the second button 134, and the third button 135 function as the water selection button, a button selected to take out the general ice, and a button selected to select the flake ice, respectively.

As described above, according to the present disclosure, whether to execute the constant water quantity supply mode is associated with the time duration for which the button as the input unit is pressed. Thus, different functions may be executed according to different modes using the same button without a separate additional input unit.

When the user presses a specific button for the first set time duration in step S100 as described above, the LED of the selected button may flicker and a buzzer sound may be generated in step S110.

Accordingly, the user may accurately and conveniently recognize which button is selected.

In this case, when the user presses one of the plurality of buttons again for the first set time duration, the process may enter step S120 in which the constant water quantity supply mode may be deactivated.

At the same time, the buzzer sound is generated, and the LED of the button flickering in step S110 stops flickering.

When the constant water quantity supply mode is deactivated, an operation mode is changed to a water purification mode before the constant water quantity supply mode is executed.

In this case, when the user continuously presses one of the plurality of buttons for the first set time duration in step S120, the process enters step S110 again, in which the constant water quantity supply mode corresponding to the selected button may be executed.

That is, the water purification mode is changed to the constant water quantity supply mode.

When the user does not input a separate command for a second set time duration in step S110, the process enters step S130 in which the constant water quantity supply mode may be deactivated. At the same time, the LED of the flickering button in step S110 stops flickering.

In this case, the second set time duration may be set to 30 seconds. However, the second set time duration may vary, and is not limited thereto.

When the user presses or continuously presses the lever 190 in step 110, the constant water quantity supply at the water volume corresponding to the selected button may be performed in step S140.

When the constant water quantity supply has been completed in step S140, the process enters step S160 in which the constant water quantity supply mode may be deactivated. At the same time, the LED of the flickering button in step S140 stops flickering.

In addition, when the user additionally presses the lever 190 in step S140, the process enters step S150 in which the constant water quantity supply mode may be deactivated. At the same time, the LED of the flickering button in step S140 stops flickering.

In one example, the water volume selected in the constant water quantity supply mode may have an error depending on the water pressure zone environment, and thus, an additional logic capable of reducing the error may be implemented.

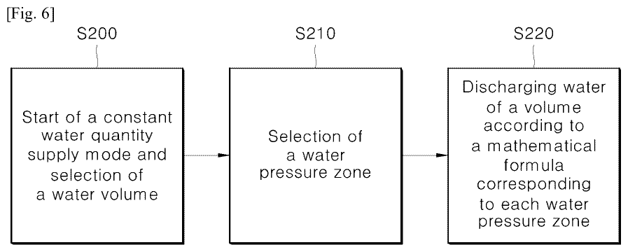

Referring to FIG. 6, when the constant water quantity supply mode is started and the water volume is selected in step S200, the controller 500 may select a water pressure zone in step S210 and may be configured to discharge water of the volume according to a mathematical formula corresponding to each water pressure zone in step S220.

Specifically, in the constant water quantity supply mode, the controller 500 may detect a water supply flow rate based on a pulse value through a flow sensor (not shown) for a predetermined time so that the water is discharged at the water volume corresponding to the selected button, determine the water pressure, and terminate the water supply when a target pulse value corresponding to the determined water pressure is reached, thereby executing the constant water quantity supply.

In this case, the flow sensor (not shown) is generally a flow meter, and the water supply flow rate may be calculated based on the pulse value corresponding to the number of revolutions of the flow meter.

The flow meter may be the means for detecting the water supply flow rate and may generate a pulse based on the rotation of an impeller under the pressure of water supplied thereto.

Accordingly, the controller 500 may integrate the pulse value based on the rotation of the impeller according to a preset mathematical formula.

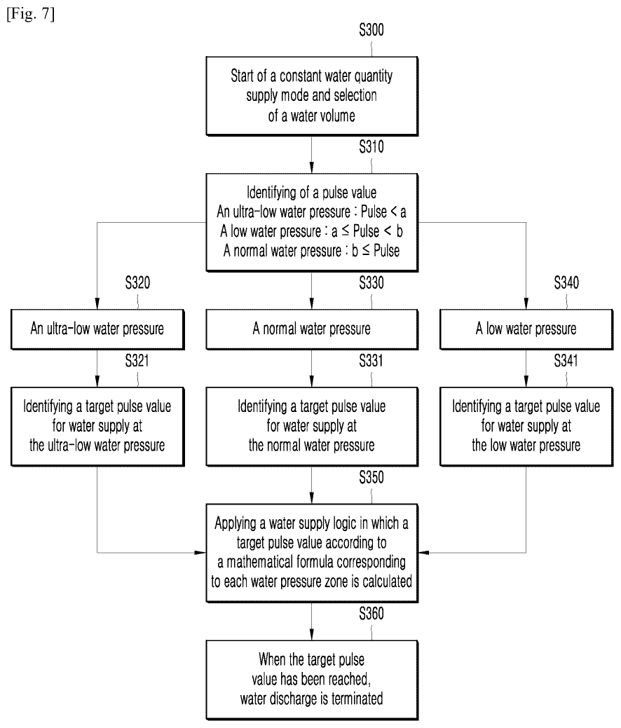

Referring to FIG. 7, a flowchart for selecting the water pressure zone will be further described.

When the constant water quantity supply mode is started and the water volume is selected in step S300, the controller 500 may compare the calculated pulse value with a predetermined value in step S310.

For example, when the pulse value<a, the water pressure may be determined as an ultra-low water pressure. When a≤pulse value<b, the water pressure may be determined as a low water pressure. When b≤pulse value, the water pressure may be determined as a normal water pressure.

In this case, each of a and b is a natural number, and may be a preset numerical value and may vary based on setting.

When the water pressure is the ultra-low water pressure at step S310 in S320, step S321 of identifying a target pulse value for water supply at the ultra-low water pressure and step S350 of applying a water supply logic in which a target pulse value according to a mathematical formula corresponding to each water pressure zone is calculated may be performed.

When the water pressure is the general water pressure at step S310 in S330, step S331 of identifying a target pulse value for water supply at the general water pressure and step S350 of applying a water supply logic in which a target pulse value according to a mathematical formula corresponding to each water pressure zone is calculated may be performed.

When the water pressure is the low pressure at step S310 in S340, step S341 of identifying a target pulse value for water supply at the low water pressure and step S350 of applying a water supply logic in which a target pulse value according to a mathematical formula corresponding to each water pressure zone is calculated may be performed.

When the target pulse value has been reached after step S350, the water discharge may be terminated in S360.

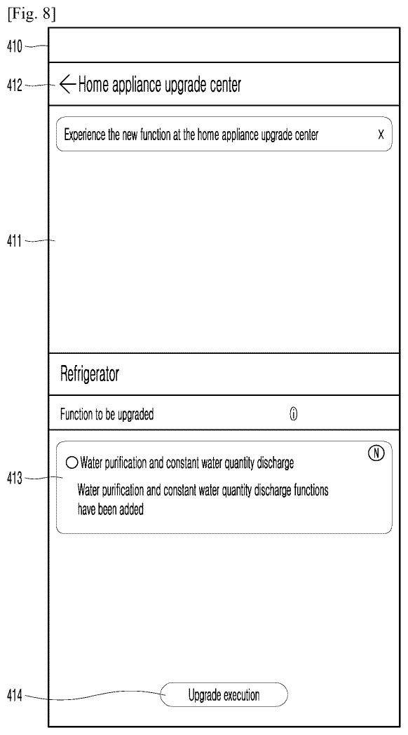

FIG. 8 illustrates a user interface 410 of a user terminal 400 that provides an upgrade alarm indication.

The user interface 410 may include a title area 412 showing a subject or product of the currently displayed screen and a main area 411 showing various information to the user.

An upgrade alarm indication 413 and an upgrade execution button 414 may be displayed in the main area 411.

The user may identify whether the additional mode can be upgraded through the upgrade alarm indication 413.

When the identified additional mode is to be upgraded in the refrigerator 1, the user presses the upgrade execution button 414, and the existing refrigerator 1 may be upgraded with the newly identified additional mode through the user terminal 400.

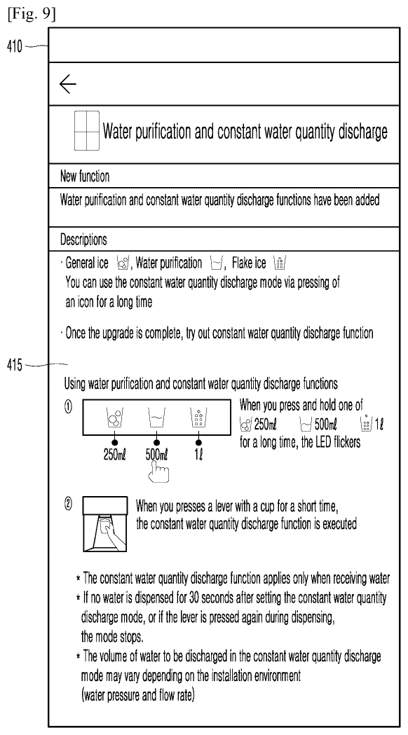

FIG. 9 illustrates a user interface 410 of a user terminal 400 that provides additional mode information on an upgraded constant water quantity supply mode.

In this case, the user interface 410 may be a screen implemented by an app downloaded to the user terminal 400. For example, the app may be a ThinQ app, but is not limited thereto.

The user interface 410 of the user terminal 400 may display additional mode information 415 indicating the information on the upgraded additional mode, so that detailed information on the function of the new additional mode may be provided in detail without being restricted to the existing display unit of the refrigerator 1.

In one example, the user interface 410 of the user terminal 400 may additionally provide an option for allowing the user to arbitrarily adjust and select the amount of water to be discharged in the constant water quantity supply mode.

For example, the user interface 410 of the user terminal 400 may provide an option for allowing the user to select a specific button so that the user may adjust the water discharge quantity according to the specific button of the dispenser 100.

In this case, the option may be provided in a text form or a graphic form. However, the present disclosure is not particularly limited thereto.

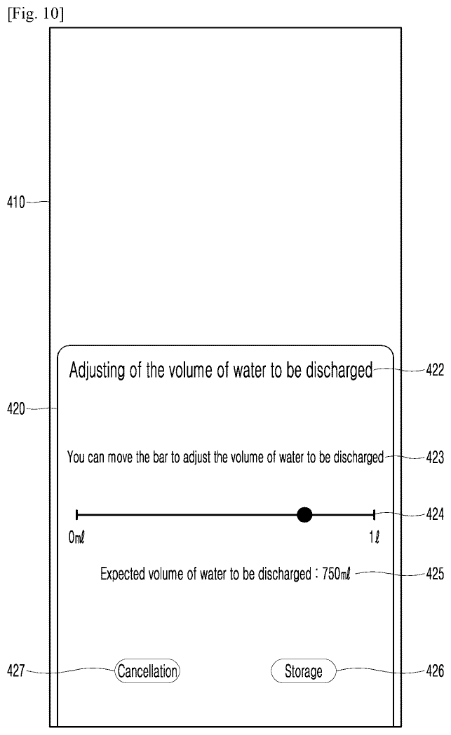

Referring to FIG. 10, when the user selects the button for adjusting the discharge quantity, the user interface 410 of the user terminal 400 may display a pop-up area 420 including a title area 422 for displaying the discharge quantity adjustment item and a description area 423 for displaying a description of the discharge quantity adjustment method.

In addition, a discharge amount adjustment item 424 may be included to adjust the discharge amount desired by the user.

In FIG. 10, an embodiment in which the discharge amount is adjusted in the form of adjusting a bar is illustrated. However, the present disclosure is not limited thereto, and the user may directly input a numerical value corresponding to the discharge amount.

When the user adjusts the discharge amount through the discharge amount adjustment item 424, the set discharge amount may be displayed on the discharge amount display portion 425.

In this case, when the user clicks a setting storage item 426, the changed quantity of water may be stored therein. When the user clicks a setting cancelation item 427, the changed quantity of water may be canceled without being stored.

As described above, the option for allowing the user to arbitrarily adjust the discharge quantity is provided, the water may be discharged at various water discharge quantities of intermediate values in addition to 250 ml, 500 ml, and 1000 ml as provided as default settings, thereby increasing user convenience.

In one example, the additional mode may be an ice-making completion notification mode in which the completion of the ice making of the dispenser 100 is guided to the user for a predetermined time duration using a notification sound such as a melody.

In this case, the user interface 410 of the user terminal 400 may provide an option for allowing the user to select on or off of the ice-making completion notification mode.

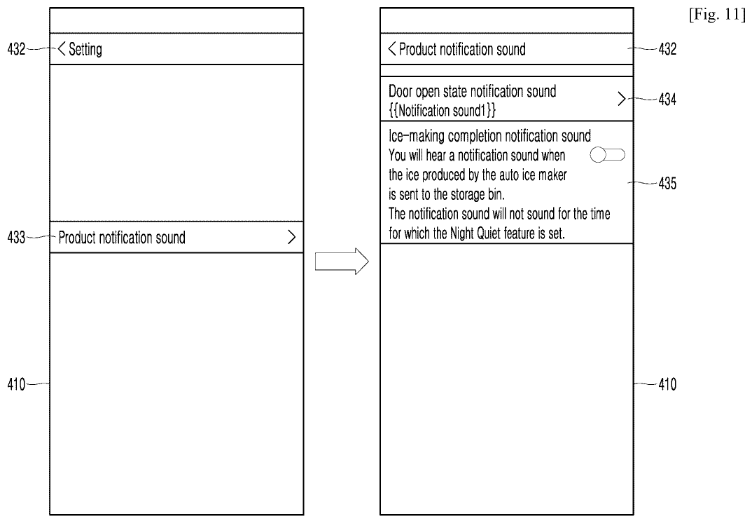

Referring to FIG. 11, the user interface 410 of the user terminal 400 may display a title area 432 and a menu tree 433 for selecting various menus.

For example, when the user selects a product notification sound from among the menus in the menu tree 433, the user interface 410 may be switched to display a notification sound type selection item 434 and an ice-making completion notification sound on/off selection item 435.

The user may select one of various types of melodies from the notification sound type selection item 434, select on or off of the ice-making completion notification mode through a click of the ice-making completion notification sound on/off selection item 435. Thus, the controller 500 of the refrigerator 1 may control the selected function to be implemented in the refrigerator 1 only via the manipulation of the user terminal 400.

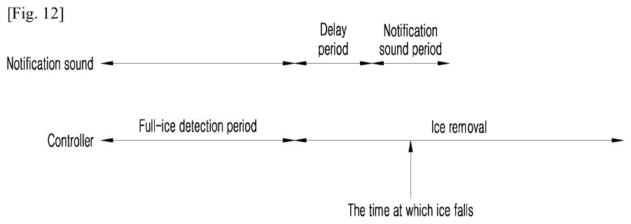

FIG. 12 is a flowchart illustrating an ice removal operation and a notification period of a notification sound through a controller after an ice-making completion notification mode is upgraded as an additional mode.

In the ice-making completion notification mode, the controller 500 may be configured to detect that the dispenser 100 is fully filled with ice and allow a notification sound to play in a process of the ice removal.

For example, the controller 500 may detect whether the ice is full in an ice tray (not shown) of the dispenser 100. When the full ice has been detected, the controller 500 may execute the ice removal step of removing the ice from the ice tray (not shown) after the full ice detection period has elapsed.

In this process, after the full ice detection period of 4.5 seconds has elapsed, and then, after a delay period of 4 seconds has elapsed, the controller 500 may allow the notification sound to sound.

The notification sound may last for 4 seconds. However, the present disclosure is not limited thereto, and the time duration of each of the full ice detection period and the delay period is not particularly limited.

In this case, the notification sound period for which the notification sound lasts may overlap a time point at which the ice falls down in the ice removal control process of the controller 500.

As described above, the notification sound period overlaps the time point at which the ice falls down, such that there is an effect that noise that may be generated during the ice removal process may be offset with the notification sound as much as possible.

In addition, the notification sound period does not start immediately after the full ice detection period. Rather, the delay period is intervened therebetween, thereby reducing unnecessary long continuation of the notification sound, and allowing the time point at which the ice falls down to generate a large noise and the notification sound period to overlap with each other as much as possible.

As described above, although the present disclosure has been described with reference to the drawings illustrated in the present disclosure, it is obvious that the present disclosure is not limited to the embodiments and drawings disclosed in the present disclosure, and various modifications may be made by a person skilled in the art within the scope of the technical idea of the present disclosure. In addition, even when the effects according to the configuration of the present disclosure are not explicitly described while describing the embodiments of the present disclosure, it is natural that the predictable effects from the configuration should also be recognized.

1. A system for controlling an additional mode of a refrigerator, the system comprising:
a user terminal;
a server communicating with the user terminal;
the refrigerator communicating with at least one of the user terminal and the server and including a dispenser, wherein an additional mode of the dispenser is upgradable by the user terminal or the server;
a user interface provided on the user terminal and configured to provide information on the additional mode;
an input unit provided on the dispenser and configured to receive a user command according to the additional mode; and
a controller configured to control execution of the additional mode in response to the user command input to the input unit.

2. The system of claim 1, wherein the additional mode is a constant water quantity supply mode in which a predetermined amount of water is discharged.

3. The system of claim 2, wherein the user interface provides an option for allowing a user to arbitrarily adjust and select a volume of water to be discharged in the constant water quantity supply mode.

4. The system of claim 2, wherein the dispenser includes a plurality of buttons corresponding to the input unit,
wherein when any one of the buttons is pressed for a predetermined time duration, the controller is configured to execute the constant water quantity supply mode.

5. The system of claim 4, wherein the plurality of buttons include a first button, a second button, and a third button,
wherein in the constant water quantity supply mode, the first button, the second button, and the third button correspond to different discharged water volumes, respectively.

6. The system of claim 5, wherein the dispenser further includes a lever,
wherein when the lever is pressed in the constant water quantity supply mode, water is discharged at a water volume corresponding to the selected button.

7. The system of claim 5, wherein in the constant water quantity supply mode, the controller is configured to:
detect a water supply flow rate based on a pulse value using a flow sensor for a predetermined time duration so that water is discharged at a water volume corresponding to the selected button;
determine a water pressure; and
in response to that a target pulse value corresponding to the determined water pressure has been reached, terminate water discharge to complete the constant water quantity supply mode.

8. The system of claim 4, wherein when one of the plurality of buttons has been pressed for a predetermined time duration in the constant water quantity supply mode or when the constant water quantity supply mode is not executed for a predetermined time duration, the constant water quantity supply mode is deactivated.

9. The system of claim 1, wherein the additional mode is an ice-making completion notification mode for guiding completion of ice-making of the dispenser.

10. The system of claim 9, wherein in the ice-making completion notification mode, the controller is configured to detect that the dispenser is fully filled with ice and to allow a notification sound to sound in a process of ice removal.

11. The system of claim 9, wherein the user interface provides an option for allowing a user to turn the ice-making completion notification mode on or off.
